(19) United States
(12) Patent Application Publication
(10) Pub. No.: US 2021/0102848 A1
(43) Pub. Date: Apr. 8, 2021

(54) Sensor Element of a Resistance Thermometer and Substrate for a Sensor Element

(71) Applicant: TE Connectivity Sensors Germany GmbH, Dortmund (DE)

(72) Inventors: Stefan Andreas Roessinger, DORTMUND (DE); Horst Sirtl, DORTMUND (DE)

(73) Assignee: TE Connectivity Sensors Germany GmbH, Dortmund (DE)

(21) Appl. No.: 17/009,471

(22) Filed: Sep. 1, 2020

(30) Foreign Application Priority Data
Oct. 4, 2019 (EP) 19201521

(51) Int. Cl. G01K 7/18; G01K 1/14

(52) U.S. Cl. CPC G01K 7/18; G01K 1/14

(57) ABSTRACT

A sensor element of a resistance thermometer includes a substrate having a first layer including lanthanum aluminate and an electrically conducting measuring structure directly arranged on the first layer. The measuring structure includes platinum.

### CROSS-REFERENCE TO RELATED APPLICATION

This application claims the benefit of the filing date under 35 U.S.C. § 119(a)-(d) of European Patent Application No. 19201521, filed on Oct. 4, 2019.

### FIELD OF THE INVENTION

The present invention relates to a sensor element and, more particularly, to a substrate for a sensor element.

### BACKGROUND

Resistance thermometers known in the art have a measuring structure made of platinum which is arranged on a substrate. The substrate and the measuring structure in known resistance thermometers have different thermal coefficients of expansion. When known resistance thermometers are stressed by abrupt changes in temperature, alterations and damage which act on the entire measuring structure and falsify the measuring values can occur at the boundary layer between the substrate and the measuring structure. Consequently, a temperature measurement made by resistance thermometers becomes more unreliable over time.

DE 10 2015 223 950 A1 discloses a substrate for a sensor element and/or element of a resistance thermometer, wherein the substrate comprises aluminum oxide and zirconium dioxide and has a thermal coefficient of expansion approximately equal to the thermal coefficient of expansion of platinum.

### SUMMARY

A sensor element of a resistance thermometer includes a substrate having a first layer including lanthanum aluminate and an electrically conducting measuring structure directly arranged on the first layer. The measuring structure includes platinum.

### BRIEF DESCRIPTION OF THE DRAWINGS

The invention will now be described by way of example with reference to the accompanying Figures, of which:

FIG. 1 is a sectional side view of a sensor element according to an embodiment;

FIG. 2 is a sectional side view of a sensor element according to another embodiment;

FIG. 3 is a sectional side view of the sensor element of FIG. 1 with a protecting layer;

FIG. 4 is a sectional side view of the sensor element of FIG. 2 with a protecting layer;

FIG. 5 is a top view of an electrically conducting structure of a sensor element; and

FIG. 6 is a sectional side view taken along line A-A of FIG. 5.

### DETAILED DESCRIPTION OF THE EMBODIMENT(S)

Embodiments of the present invention will be described hereinafter in detail with reference to the attached drawings, wherein similar reference numerals refer to similar elements. The present invention may, however, be embodied in many different forms and should not be construed as being limited to the embodiments set forth herein; rather, these embodiments are provided in such a way that the disclosure will convey the concept of the invention to those skilled in the art.

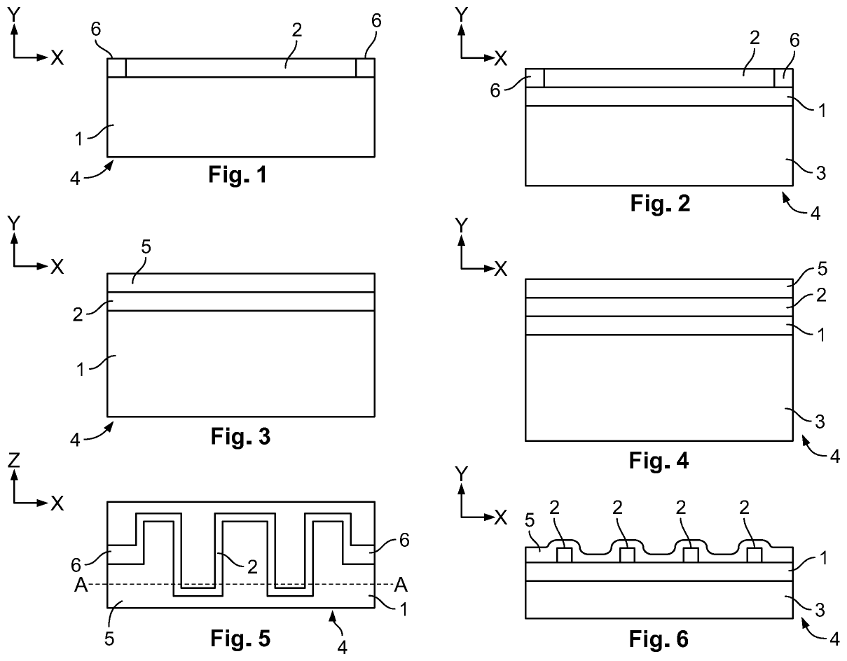

FIG. 1 shows a sectional view of a sensor element according to an embodiment of a resistance thermometer. The sensor element comprises a substrate 4 which in this embodiment has only a first layer 1. On an upper side of the first layer 1, an electrically conducting measuring structure 2 is arranged. The electrically conducting measuring structure 2 is directly arranged on the first layer 1.

The electrically conducting measuring structure 2 may include or may be made or consist of platinum. In another embodiment, the electrically conducting measuring structure 2 may comprise small amounts of rhodium dispersed in the platinum for a better long term stabilization of the electrically conducting structure 2.

The first layer 1 may include or may be made or consist of lanthanum aluminate. Therefore, the substrate 4 includes or is made or consists of lanthanum aluminate. Lanthanum aluminate (LaAlO₃) has a molar mass of 213.89 g/mol, a density of about 6.52 g/cm³, a melting point of about 2080° C. and is a crystalline material with a relatively high relative dielectric constant of 25. The crystal structure of lanthanum aluminate is a rhombohedral distorted perovskite with a pseudocubic lattice parameter of 3.787 Ångström at room temperature. Lanthanum aluminate is an optically transparent ceramic oxide.

The first layer 1 may be embodied as an epitaxially grown thin film of lanthanum aluminate which may be deposited by a pulsed laser deposition or a molecular beam epitaxy. In this embodiment, the substrate 4 may be embodied as an epitaxially grown film of lanthanum aluminate which may be deposited by a pulsed laser deposition or a molecular beam epitaxy.

The first layer 1 may be produced by screen printing. During the fabrication of the first layer 1 using a screen print process, the lanthanum aluminate is provided as a paste or liquid, wherein powder of lanthanum aluminate is arranged in a solvent. After the deposition of the paste including lanthanum aluminate or fluid including lanthanum aluminate on a carrier, the solvent is baked out and the first layer 1 made of lanthanum aluminate is attained. In the case, the substrate 4 only includes the first layer 1, then the substrate 4 can be produced by the screen printing process using a paste or a liquid including lanthanum aluminate. Furthermore, the first layer 1 or the substrate 4 may be embodied as a non-epitaxial lanthanum aluminate film. The lanthanum aluminate has between 0° C. and 1000° C. a thermal coefficient of expansion of about 10×10⁻⁶×K⁻¹.

The substrate 4 with the first layer 1 serves as a support for the electrically conducting measuring structure 2, which can be fragile. The electrically conducting measuring structure 2 may be embodied as a meandering structure. However, the electrically conducting measuring structure 2 may also have a different shape for example a straight small line or a rectangular layer or a layer with the same area as the first layer 1.

The measuring structure 2 may be used as an electrical resistance structure, for example. The measuring structure 2, as shown in FIG. 1, may include at least one contact area 6 for building at least one solder joint to connect to a PCB or at least one welding joint where an electrical conductive wire could be applied. The contact area 6 could be provided directly on the same surface of the first layer 1 as the measuring structure 2. It is also possible to arrange the contact area 6 with a via hole on the opposite side of the first layer 1 or of the substrate 4. The electrical resistance of the electrically conducting structure 2 changes depending on the temperature. The change in resistance can be measured and the temperature can be deduced from the resistance change.

The first layer 1 of the substrate 4 or the substrate 4 itself can have a thermal coefficient of expansion approximately equal to the thermal coefficient of expansion of the electrically conducting structure 2. For example, the deviation between the thermal coefficient of expansion of the first layer 1 and the electrically conducting structure 2 may be smaller than 5%, smaller than 3% or smaller than 2%, smaller than 1% or even less. The thermal coefficient of expansion of the first layer 1 and the thermal coefficient of expansion of the electrically conducting structure 2 are adapted to one another and can in particular deviate from one another within the specified ranges in a region relevant for measuring, for example in a region in which the sensor element is operated later, for instance from lower than −200° C. to +1000° C. or even higher temperatures. The small deviation of the thermal coefficient of expansion of the first layer 1 and of the electrically conducting measuring structure 2 results in less stress for the electrically conducting structure 2 during the operation of the resistance thermometer.

Depending on the used embodiment, the first layer 1 may be made of or consists of lanthanum aluminate. Therefore, the substrate 4 may be made of or consists of lanthanum aluminate. In a further embodiment, the first layer 1 may additionally to the lanthanum aluminate comprise a metal oxide, for example Y₂O₃, ZrO₂, MgO or TiO₂. The additional metal oxides beside the lanthanum aluminate allow a more precise adaption of the thermal coefficient of expansion of the first layer 1 to the thermal coefficient of expansion of the electrically conducting structure 2. For example, the first layer 1 may comprise between 0.1 weight percent and 5 weight percent metal oxide.

The thickness of the first layer 1 along the Y-axis shown in FIG. 1 may be 100 μm and more. Therefore, the substrate 4 has a thickness along the Y-axis which is 100 μm and more. Furthermore, depending on the used embodiment, the substrate 4 may be arranged on a further carrier.

The electrically conducting measuring structure 2 may be made of platinum or may include platinum. Platinum has a thermal coefficient of expansion of about 8.8×10⁻⁶×K⁻¹ at room temperature and 10×10⁻⁶×K⁻¹ between 0° C. and 1000° C. Depending on the used embodiment, the platinum lattice of the electrically conducting layer 2 is doped with rhodium or iridium. For example, the platinum may be doped with rhodium or iridium in a region of 0.05 to 1 weight percent, 2 weight percent, or more. The electrically conducting structure 2 may have a thickness of about 400 nm to 1500 nm along the y-axis in a direction vertical to the upper side of the first layer 1.

FIG. 2 shows a further embodiment of the sensor element of a resistance thermometer, wherein the substrate 4 includes additional to the first layer 1 a second layer 3, wherein the first layer 1 is arranged on the second layer 3 and between the second layer 3 and the measuring structure 2.

The first layer 1 may have the same properties as described with regard to the embodiment of FIG. 1. The first layer 1 may have a smaller thickness compared to the embodiment of FIG. 1 since a part of the mechanical stability of the substrate 4 may be provided by the second layer 3.

The second layer 3 may be made of a material which has a higher electrical conductivity, for example at least 20% higher, than the material of the first layer 1. Furthermore, the second layer 3 may have a higher mechanical stability, for example at least 20% higher, than the material of the first layer 1. For example, the second layer 3 may be, for example, made of ZrO₂. Depending on the used embodiment, the second layer 3 may also be made of another metal oxide for example TiO₂ or MgO. Furthermore, the second layer 3 may for example be made of another material, for example, glass, semiconductor or metal.

The second layer 3 may have a larger thickness along the y-axis shown in FIG. 2 than the first layer 1. The thickness of the second layer 3 may be three times or more than the thickness of the first layer 1. Depending on the used embodiment, the second layer 3 may also have another thickness. The substrate 4 may have a thickness along the y-axis of 100 μm or more.

On top of the first layer 1, the electrically conducting measuring structure 2 is arranged, as shown in FIG. 2. The electrically conducting measuring structure 2 may be identical to the electrically conducting measuring structure 2 of the embodiment of FIG. 1. In this embodiment, the first layer 1 may have a thickness between 1 μm and 5 μm, or between 1 μm and 10 μm. Depending on the used embodiment, the first layer 1 may also have a thickness greater than 5 μm. The second layer 3 may have a thickness which is at least three times thicker than the first layer 1 and which may have, for example, a thickness between 50 μm and 200 μm. The electrically conducting structure 2 may have a thickness of about 400 nm to 1500 nm along the y-axis in a direction vertical to the upper side of the first layer 1.

The first layer 1, in an embodiment, electrically insulates the electrically conducting measuring structure 2 from the second layer 3. This embodiment has the advantage that only a thin first layer 1 is necessary and sufficient to provide an electrical insulation layer between the second layer 3 and the measuring structure 2. Therefore, the second layer 3 can be made of a material which provides a higher mechanical stability and/or which can be produced more easily. For example, the second layer 3 is made of ZrO₂ and the first layer 1 is a lanthanum-aluminate layer that functions as electrically insulation layer that insulates the electrically conducting measuring structure 2 from the second layer 3.

A method for producing the sensor element includes providing the substrate 4 including the first layer 1 of lanthanum aluminate and forming the electrically conducting structure 2 including platinum on the first layer 1.

FIG. 3 shows a sectional view of a further embodiment of the sensor element according to FIG. 1, wherein the electrically conducting measuring structure 2 is covered by a protecting layer 5. The protecting layer 5 covers a free surface of the electrically conducting measuring structure 2. The protecting layer 5 may, for example, be made of lanthanum aluminate or may comprise lanthanum aluminate. In a further embodiment, the protecting layer 5 additionally to the lanthanum aluminate comprises additionally one or several metal oxides, for example Y₂O₃, ZrO₂, MgO, or TiO₂. The metal oxides have the advantage that the thermal coefficient of expansion of the protecting layer 5 can be adapted more precisely to the thermal expansion coefficient of platinum. Therefore, less thermal stress between the electrically conducting structure 2 and the protecting layer 5 is attained.

The protecting layer 5 is embodied in such a way that the whole free surface of the electrically conducting measuring structure 2 is covered by the protecting layer 5. Therefore, the electrically conducting measuring structure 2 is protected against environmental influences, for example moisture, dirt or gas. The protecting layer 5 may have a thickness along the y-axis of about 1 to 5 μm, or about 1 to 10 μm. Depending on the used embodiment, the protecting layer 5 may also have a different thickness. The protecting layer 5 may be deposited by the same processes as the first layer 1, for example, by a screen print process, a sputter process or a pulsed laser deposition process. Furthermore, the protecting layer 5 may be made of other materials, for example, glass.

The protecting layer 5 results in a sufficient electrical insulation, mechanical and chemical protection of the electrically conducting structure 2 and in a low thermal stress between the protecting layer 5 and the electrically conducting structure 2. Furthermore, the production of the sensor element is simplified since the deposition of lanthanum aluminate is performed for producing the first layer 1. Therefore, the same equipment may be used for producing the first layer 1 and the protecting layer 5.

FIG. 4 shows a sectional view of a further embodiment with regard to the embodiment of FIG. 2. In this embodiment, the electrically conducting measuring structure 2 is covered by a protecting layer 5. The protecting layer 5 may be made of the same material and/or the same processes as the protecting layer 5 of FIG. 3.

FIG. 5 shows a schematic view on top of a substrate 4 which comprises at least the first layer 1 or as discussed above additionally a second layer 3. On top of the first layer 1, the electrically conducting measuring structure 2 is arranged. The electrically conducting measuring structure 2 is made of the same material and with the same design as discussed with regard to the FIGS. 1 to 4. In the shown embodiment, the electrically conducting measuring structure 2 has the shape of a meander structure. Depending on the used embodiment, the electrically conducting structure 2 may also have different shapes.

FIG. 6 shows a schematic sectional view along an A-A line as shown in FIG. 5. The protecting layer 5 covers the free surface of the electrically conducting structure 2 and also covers the upper side of the first layer 1.

The substrate 4 for a sensor element of a resistance thermometer according to the embodiments described herein provides less thermal stress between the electrically conducting measuring structure 2 and the substrate 4.

What is claimed is:

1. A sensor element of a resistance thermometer, comprising:
a substrate having a first layer including lanthanum aluminate; and
an electrically conducting measuring structure directly arranged on the first layer, the measuring structure includes platinum.

2. The sensor element of claim 1, wherein the first layer consists of lanthanum aluminate.

3. The sensor element of claim 1, wherein the first layer includes a metal oxide.

4. The sensor element of claim 1, wherein the substrate has a second layer, the first layer is arranged on the second layer.

5. The sensor element of claim 4, wherein the second layer has a higher electrical conductivity than the first layer.

6. The sensor element of claim 5, wherein the first layer electrically insulates the electrically conducting measuring structure from the second layer.

7. The sensor element of claim 5, wherein the second layer includes ZrO₂.

8. The sensor element of claim 4, wherein the first layer has a thickness between 1 μm and 10 μm.

9. The sensor element of claim 1, wherein the measuring structure includes rhodium.

10. The sensor element of claim 9, wherein the rhodium is between 0.05 weight percent and 1 weight percent of the measuring structure.

11. The sensor element of claim 1, wherein the measuring structure includes iridium.

12. The sensor element of claim 1, further comprising a protecting layer covering the measuring structure.

13. The sensor element of claim 12, wherein the protecting layer includes lanthanum aluminate.

14. A sensor element, comprising:
a substrate with at least one layer;
a measuring structure including platinum; and
a protecting layer covering the measuring structure, the protecting layer includes lanthanum aluminate.

15. The sensor element of claim 14, wherein the protecting layer has a thickness between 1 μm and 10 μm.

16. A substrate for a sensor element of a resistance thermometer, comprising:
a first layer including lanthanum aluminate, a thermal coefficient of expansion of the first layer is approximately equal to the thermal coefficient of expansion of platinum.

17. The substrate of claim 16, wherein the first layer consists of lanthanum aluminate.

18. The substrate of claim 16, further comprising a second layer, the first layer is arranged on the second layer.

19. The substrate of claim 18, wherein the second layer has a higher electrical conductivity than the first layer.

20. A method for producing a sensor element, comprising:
providing a first layer including lanthanum aluminate; and
forming an electrically conducting measuring structure including platinum on the first layer.
